(19) United States
(12) Patent Application Publication
(10) Pub. No.: US 2023/0311866 A1
(43) Pub. Date: Oct. 5, 2023

(54) MOVING BODY CONTROL DEVICE, MOVING BODY CONTROL METHOD, AND NON-TRANSITORY COMPUTER-READABLE STORAGE MEDIUM

(71) Applicant: HONDA MOTOR CO., LTD., Tokyo (JP)

(72) Inventor: Shota ISHIKAWA, Saitama (JP)

(21) Appl. No.: 18/190,332

(22) Filed: Mar. 27, 2023

(30) Foreign Application Priority Data
Mar. 31, 2022 (JP) 2022-059538

(51) Int. Cl. B60W 30/095; B60W 50/14; G08G 1/0967; G06V 20/58; G06V 20/56

(52) U.S. Cl. CPC B60W 30/0956; B60W 50/14; G08G 1/0967; G06V 20/58; G06V 20/588; B60W 2554/4041; B60W 2554/4045; B60W 2554/4046; B60W 2552/10; B60W 2554/4044; G06V 2201/08

(57) ABSTRACT

A control device includes an external environment recognizing unit that recognizes a surrounding situation of a moving body based on external environment recognition data acquired from an external environment sensor, and a prediction unit that, based on the surrounding situation, performs prediction regarding rush-out of a moving obstacle to a first lane in which the moving body is positioned. The external environment recognizing unit recognizes, as the surrounding situation, behavior of opposite-direction moving bodies moving in a second lane adjacent to the first lane in a direction opposite to a moving direction of the moving body, the opposite-direction moving bodies including a first another moving body positioned in the moving direction of the moving body and a second another moving body moving behind the first another moving body. The prediction unit predicts a possibility of rush-out of the moving obstacle based on a behavior of the second another moving body.

### TECHNICAL FIELD

The present invention relates to a control device, a control method, and a control program (stored in a non-transitory computer-readable storage medium) for a moving body.

### BACKGROUND ART

In recent years, efforts are being actively made to provide access to a sustainable transportation system which takes into account persons who are in a vulnerable position among traffic participants. To achieve this, the applicant of the present application is focused on research and development to further improve traffic safety and convenience via research and development related to driving assistance technology.

Regarding the conventional driving assistance technology, there is known a pedestrian recognition device which, when a change that a line of oncoming vehicles breaks up is detected, for example, decides a recognition condition that enables easy detection of a posture of a pedestrian that is likely to occur at the time of brake-up of the line of vehicles, whereby the pedestrian recognition device recognizes a pedestrian based on the recognition condition and performs determination regarding rush-out of the pedestrian based on the image data related to the recognized pedestrian (see JP2013-008315A).

Incidentally, in a case where there is another moving body in an area adjacent to the course of the moving body, if an object rushes out from behind the other moving body (namely, from a blind spot for the moving body), it may be difficult to detect the rush-out of the object by an external environment sensor provided on the moving body because an occlusion may occur due to overlap of the object with the other moving body.

More specifically, in a case where there is another vehicle in a lane (for example, an oncoming lane) adjacent to the lane in which the own vehicle is traveling, it may be difficult to detect a pedestrian, an animal, or the like rushing out from behind the other vehicle with a camera, radar, sonar, and the like. Thus, in such a case, with the conventional technology described in the aforementioned JP2013-008315A, determination of rush-out of a pedestrian by use of the image data obtained by the camera may become difficult.

Therefore, in the vehicle driving assistance technology also, it is a challenge to make it possible to predict rush-out of an object from behind another vehicle present around the own vehicle in such an environment where an occlusion may occur. By solving such a problem, it is possible in the own vehicle to start control related to steering and/or braking for avoiding a rushing-out object at an earlier timing thereby to improve traffic safety.

### SUMMARY OF THE INVENTION

In view of the foregoing background, a primary object of the present invention is to provide a control device, a control method, and a control program (stored in a non-transitory computer-readable storage medium) for a moving body, which can predict rush-out of an object from behind another moving body present around the moving body. By achieving such an object, the present invention contributes to development of a sustainable transportation system.

To achieve the above object, one aspect of the present invention provides a control device (20) for a moving body (1), comprising: an external environment recognizing unit (31) that acquires external environment recognition data around the moving body from an external environment sensor and recognizes a surrounding situation of the moving body based on the external environment recognition data; and a prediction unit (33) that, based on the surrounding situation, performs prediction regarding rush-out of a moving obstacle (61) to a first lane (51) in which the moving body is positioned, wherein the external environment recognizing unit recognizes, as the surrounding situation, a behavior of a group of opposite-direction moving bodies (55) constituted of multiple other moving bodies moving in a second lane (53) adjacent to the first lane in an opposite direction to the moving body, the group of opposite-direction moving bodies including a first another moving body (57) which is positioned in the moving direction of the moving body and a second another moving body (59) which is moving behind the first another moving body, and the prediction unit predicts a possibility of rush-out of the moving obstacle based on a behavior of the second another moving body.

With this configuration, based on the behavior of the second another moving body which is positioned in the second lane adjacent to the first lane (the lane in which the moving body is positioned) and which is moving behind the first another moving body, it is possible to predict rush-out of an object (moving obstacle) from behind the first another moving body present around the moving body (in the second lane).

Preferably, the control device further comprises a storage unit (19) that stores statistical data (27) related to a normal behavior of the second another moving body, wherein the prediction unit determines that there is a possibility of rush-out of the moving obstacle when the behavior of the second another moving body recognized by the external environment recognizing unit is determined to be different from the normal behavior based on the statistical data.

With this configuration, it is possible to predict the possibility of rush-out of a moving obstacle with a simple configuration using statistical data related to a normal behavior of the second another moving body.

Preferably, the prediction unit determines that there is a possibility of rush-out of the moving obstacle when the behavior of the second another moving body includes a deceleration of the second another moving body greater than a deceleration of the first another moving body.

With this configuration, it is possible to easily recognize that the behavior of the second another moving body is different from a normal behavior based on the relative relationship between the deceleration of the first another moving body and the deceleration of the second another moving body.

Preferably, the external environment recognizing unit recognizes, as the surrounding situation, a behavior of the moving obstacle, the control device further comprises: a detection unit (34) that detects rush-out of the moving obstacle from the second lane to the first lane based on the behavior of the moving obstacle; and a control unit (32) that performs movement control of the moving body according to rush-out of the moving obstacle, and the control unit executes first movement control when it is determined by the prediction unit that there is a possibility of rush-out of the moving obstacle and executes second movement control when, after execution of the first movement control, rush-out of the moving obstacle is detected by the detection unit.

With this configuration, different movement controls (the first and second movement controls) are executed in stages when it is determined that there is a possibility of rush-out of the moving obstacle based on the behavior of the second another moving body and when the rush-out is detected based on the behavior of the moving obstacle, and therefore, appropriate control can be executed in relation to rush-out of the moving obstacle.

Preferably, the external environment recognizing unit recognizes, as the surrounding situation, a behavior of the moving obstacle, the control device further comprises: a detection unit (34) that detects rush-out of the moving obstacle from the second lane to the first lane based on the behavior of the moving obstacle; a control unit (32) that performs movement control of the moving body according to rush-out of the moving obstacle; and a warning unit (35, 36, 37) that provides a warning according to rush-out of the moving obstacle, the warning unit provides a warning to a user of the moving body when it is determined by the prediction unit that there is a possibility of rush-out of the moving obstacle, and the control unit executes the movement control when, after the warning, rush-out of the moving obstacle is detected by the detection unit.

With this configuration, when it is determined that there is a possibility of rush-out of a moving obstacle based on the behavior of the second another moving body, warning is given to the user, and when the rush-out is detected based on the behavior of the moving obstacle, the movement control is executed, whereby it is possible to execute control related to rush-out of a moving obstacle without discomfort to the user.

Preferably, the warning unit provides a further warning to surroundings of the moving body when it is determined by the prediction unit that there is a possibility of rush-out of the moving obstacle.

With this configuration, when it is determined that there is a possibility of rush-out of a moving obstacle based on the behavior of the second another moving body, a warning is provided to the surroundings of the moving body, and when the rush-out is detected based on the behavior of the moving obstacle, the movement control is executed, and therefore, the movement control in relation to rush-out of a moving obstacle can be executed without discomfort to the surroundings of the moving body (such as the surrounding pedestrians, occupants of the surrounding vehicles, etc.).

Preferably, the moving body is a vehicle traveling in a certain lane as the first lane, and the group of opposite-direction moving bodies includes multiple other vehicles traveling in, as the second lane, an oncoming lane adjacent to the certain lane.

With this configuration, based on the behavior of the second another vehicle which is positioned in the second lane (oncoming lane) adjacent to the first lane (the certain lane or the lane in which the own vehicle is positioned) and is moving behind the first another vehicle, it is possible to predict rush-out of a moving obstacle from behind the first another vehicle present around the own vehicle (in the second lane).

Preferably, the external environment recognizing unit recognizes, based on the external environment recognition data, a behavior of a group (65) of same-direction moving bodies constituted of multiple other moving bodies moving in a third lane (63) adjacent to the first lane in a same direction as the moving body, and the prediction unit predicts a possibility of rush-out of the moving obstacle from the third lane to the first lane based on a behavior of a third another moving body (67), which is a moving body in the group of same-direction moving bodies that is positioned in the moving direction of the moving body.

With this configuration, based on the behavior of the third another moving body moving in the third lane adjacent to the first lane in which the moving body is positioned, it is possible to predict rush-out of a moving obstacle from behind the third another moving body which is present around the moving body (in the third lane) (or rush-out of a moving obstacle positioned in front of the third another moving body).

Preferably, the prediction unit acquires, as the prediction regarding rush-out of the moving obstacle, a score indicating the possibility of rush-out of the moving obstacle based on a learned learning model (71) which is obtained by carrying out machine learning for estimating the possibility of rush-out of the moving obstacle.

With this configuration, rush-out of an object (moving obstacle) from behind the first another moving body present around the moving body (in the second lane) can be properly predicted based on the learning model.

To achieve the above object, another aspect of the present invention provides a control method for a moving body (1), in which one or more processors (20) execute: acquiring external environment recognition data around the moving body from an external environment sensor; recognizing, based on the external environment recognition data, a behavior of a group of opposite-direction moving bodies (55) constituted of multiple other moving bodies moving in a second lane (53) adjacent to a first lane (51), in which the moving body is positioned, in an opposite direction to the moving body, the group of opposite-direction moving bodies including a first another moving body (57) which is positioned in the moving direction of the moving body and a second another moving body (59) which is moving behind the first another moving body; and predicting a possibility of rush-out of a moving obstacle from the second lane to the first lane based on a behavior of the second another moving body.

With this configuration, based on the behavior of the second another moving body which is positioned in the second lane adjacent to the first lane (the lane in which the moving body is positioned) and which is moving behind the first another moving body, it is possible to predict rush-out of an object (moving obstacle) from behind the first another moving body present around the moving body (in the second lane).

To achieve the above object, one aspect of the present invention provides a non-transitory computer-readable storage medium, comprising a stored program, wherein the program, when executed by a processor, executes the aforementioned method.

With this configuration, based on the behavior of the second another moving body which is positioned in the second lane adjacent to the first lane (the lane in which the moving body is positioned) and which is moving behind the first another moving body, it is possible to predict rush-out of an object (moving obstacle) from behind the first another moving body present around the moving body (in the second lane).

According to the above aspect, it is possible to provide a control device, a control method, and a control program (stored in a non-transitory computer-readable storage medium) for a moving body, which can predict rush-out of an object from behind another moving body present around the moving body.

### BRIEF DESCRIPTION OF THE DRAWINGS

FIG. 1 is an overall configuration diagram showing a vehicle according to the first embodiment of the present invention;

FIG. 2 is an explanatory diagram related to rush-out prediction based on a behavior of a following vehicle traveling in an oncoming lane;

FIG. 3 is a flowchart showing a flow of process for prediction of rush-out of a moving obstacle from the oncoming lane to the driving lane by a control device according to the first embodiment;

FIG. 4 is a flowchart showing a flow of process of rush-out prediction control and rush-out detection control executed by the control device according to the first embodiment;

FIG. 5 is a flowchart showing a flow of a first modification of the process of rush-out prediction control and rush-out detection control shown in FIG. 4;

FIG. 6 is a flowchart showing a flow of a second modification of the process of rush-out prediction control and rush-out detection control shown in FIG. 4;

FIG. 7 is an explanatory diagram related to rush-out prediction based on a behavior of a following vehicle traveling in an adjacent same-direction lane;

FIG. 8 is a flowchart showing a flow of process for prediction of rush-out of a moving obstacle from the adjacent same-direction lane to the driving lane by the control device according to the first embodiment;

FIG. 9 is an overall configuration diagram showing a vehicle according to the second embodiment; and

FIG. 10 is a flowchart showing a flow of process for prediction of rush-out of a moving obstacle from the oncoming lane to the driving lane by a control device according to the second embodiment.

### DETAILED DESCRIPTION OF THE INVENTION

In the following, embodiments of the present invention will be described with reference to the drawings.

### First Embodiment

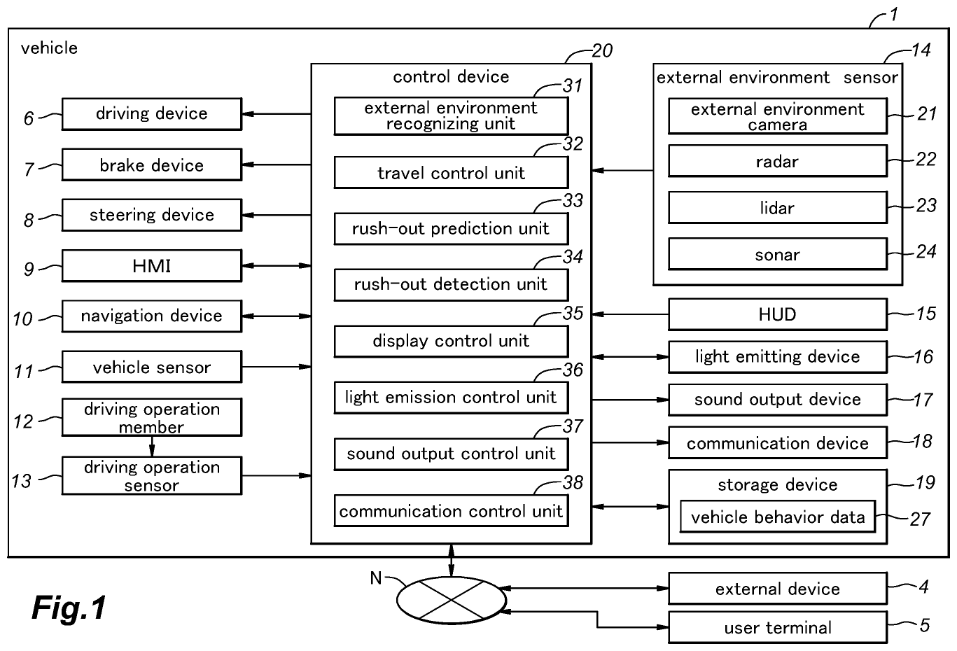

With reference to FIG. 1, a vehicle 1 according to the first embodiment of the present invention will be described. In the present embodiment, an example in which the vehicle 1 (an example of the moving body) is controlled by a control device 20 (an example of the control device for a moving body) is shown.

The vehicle 1 is connected to an external device 4 and a user terminal 5 in a communicable manner via a communication network N such as the internet.

The external device 4 is a computer including known hardware such as a computational processing device (a processor such as a CPU, an MPU, etc.), a memory (a ROM, a RAM, etc.), a storage (an HDD, an SSD, etc.), and a communication device (a network card, etc.). For example, the external device 4 is configured by a server that provides data and programs necessary for the processing executed by the control device 20 of the vehicle 1. Note that the external device 4 may execute some of the later-described functions of the control device 20 by cooperating with the control device 20.

Similarly to the external device 4, the user terminal 5 is a portable computer including known hardware such as a computational processing device, a memory, a storage, and a wireless communication device. For example, the user terminal 5 is configured by a smartphone or a tablet terminal carried by a user of the vehicle 1 (an occupant including a driver).

The vehicle 1 is a four-wheeled automobile, for example. The vehicle 1 includes a driving device 6, a brake device 7, a steering device 8, a human machine interface (HMI) 9, a navigation device 10, a vehicle sensor 11, a driving operation member 12, a driving operation sensor 13, an external environment sensor 14, a head up display (HUD) 15, a light emitting device 16, a sound output device 17, a communication device 18, a storage device 19, and a control device 20.

The driving device 6 is a device that gives a driving force to the vehicle 1. For example, the driving device 6 includes an internal combustion engine such as a gasoline engine and a diesel engine and/or an electric motor. The driving device 6 includes an electric generator (or an electric motor) that functions as a regenerative brake.

The brake device 7 is a device that gives a braking force to the vehicle 1. For example, the brake device 7 includes a brake caliper for pressing a pad against a brake rotor and an electric cylinder that supplies oil pressure to the brake caliper.

The steering device 8 is a device that changes the steering angle of the wheels. For example, the steering device 8 includes a rack-and-pinion mechanism for steering the wheels and an electric motor for driving the rack-and-pinion mechanism.

The HMI 9 is a device that displays information related to the vehicle 1 to be viewable by the driver (an example of the user) and receives information input by the driver. The HMI 9 is installed inside the vehicle 1 (for example, in the dashboard). The HMI 9 includes a touch panel equipped with a display screen.

The navigation device 10 is a device that guides a route to the destination of the vehicle 1 or the like. The navigation device 10 stores map information. The navigation device 10 identifies the current position of the vehicle 1 (latitude and longitude) based on the GNSS signal received from artificial satellites (positioning satellites). The navigation device 10 sets a route to the destination of the vehicle 1 based on the map information, the current position of the vehicle 1, and the destination of the vehicle 1 input by the driver via the HMI 9.

The vehicle sensor 11 is a sensor for detecting various vehicle states. For example, the vehicle sensor 11 preferably includes a vehicle speed sensor which detects a speed of the vehicle 1, an acceleration sensor which detects an acceleration of the vehicle 1, a yaw rate sensor which detects an angular velocity of the vehicle 1 about a vertical axis, a direction sensor which detects a direction of the vehicle 1, and so on. The vehicle sensor 11 outputs a detection result to the control device 20.

The driving operation member 12 is a device that receives a driving operation performed by the driver to drive the vehicle 1. The driving operation member 12 includes a steering wheel that receives a steering operation performed by the driver, an accelerator pedal that receives an acceleration operation performed by the driver, and a brake pedal that receives a deceleration operation performed by the driver.

The driving operation sensor 13 is a sensor for detecting an amount of driving operation performed on the driving operation member 12. In other words, the driving operation sensor 13 is a sensor that acquires information related to the driving operation performed on the driving operation member 12. The driving operation sensor 13 includes a steering angle sensor that detects a rotation angle of the steering wheel, an accelerator sensor that detects a depression amount of the accelerator pedal, and a brake sensor that detects a depression amount of the brake pedal. The driving operation sensor 13 outputs a detection result to the control device 20.

The external environment sensor 14 is a sensor that detects a state of the external environment of the vehicle 1. For example, the external environment sensor 14 detects a relative position of each of target objects present around the vehicle 1 with respect to the vehicle 1. In other words, the external environment sensor 14 acquires position information of each target object. The target objects include other vehicles such as preceding vehicles, oncoming vehicles, and parallel running vehicles, and movable objects that can interfere with the travel (hereinafter referred to as “moving obstacles”) such as pedestrians, animals, and bicycles that are present around the vehicle 1. The external environment sensor 14 outputs the detection result to the control device 20.

The external environment sensor 14 includes multiple external environment cameras 21, multiple radars 22, multiple lidars 23 (LiDAR), and multiple sonars 24. The external environment cameras 21 capture images of the target objects present around the vehicle 1. The radars 22 emit radio waves such as millimeter waves to the surroundings of the vehicle 1 and receive the reflected waves thereby to detect the relative position of each of the target objects present around the vehicle 1 with respect to the vehicle 1. The lidars 23 emit light such as infrared light to the surroundings of the vehicle 1 and receive the reflected light thereby to detect the relative position of each of the target objects present around the vehicle 1 with respect to the vehicle 1. The sonars 24 emit ultrasonic waves to the surroundings of the vehicle 1 and receive the reflected waves thereby to detect the relative position of each of the target objects present around the vehicle 1 with respect to the vehicle 1.

The HUD 15 is a device for displaying the information on the target objects so as to be superimposed over the driver's front sight (a predetermined area of the front windshield) or another occupant's sight.

The light emitting device 16 includes lamps and other lighting devices (including a device for notification). The light emitting device 16 includes at least one of the turn signals, hazard lights, tail lamps, headlights, side marker lights, fog lights, etc. The light emitting device 16 normally operates in accordance with operation of the operation switches for the light emitting device 16 by the occupant.

The sound output device 17 is a device for outputting sound to the cabin and/or to the outside of the vehicle. The sound output device 17 includes at least one of an interior speaker installed in an appropriate position in the cabin and an exterior speaker installed in an appropriate position of the vehicle body. The sound output device 17 normally operates in accordance with operation of the operation switches for the sound output device 17 by the occupant.

The communication device 18 is equipped with known hardware, such as an antenna, a modem, and a wireless communication circuit, for communicating with other devices via the communication network N. Note that the communication device 18 may communicate with the devices around it by near field communication based on Bluetooth (registered trademark), Wi-Fi, or the like without using the communication network N.

The storage device 19 is a storage that stores information used in the processing performed by the control device 20. For example, the storage device 19 includes a hard disk drive (HDD), a solid state drive (SSD), an SD memory card, or the like. The storage device 19 stores vehicle behavior data 27 related to other vehicles traveling around the vehicle 1, where the vehicle behavior data 27 is collected in advance. The other vehicles traveling around the vehicle 1 include, for example, a group of vehicles traveling in a lane adjacent to the lane in which the own vehicle is positioned (hereinafter referred to as a “driving lane”).

For example, the vehicle behavior data 27 includes statistical data related to the behavior of a vehicle traveling behind a certain vehicle positioned in an oncoming lane, which is an example of a predetermined lane (hereinafter, the certain vehicle traveling in the oncoming lane will be referred to as an “oncoming vehicle” and the vehicle traveling behind the oncoming vehicle will be referred to as a “following vehicle”). The statistical data related to the behavior of the following vehicle includes data related to braking of the following vehicle (for example, the magnitude of deceleration), the inter-vehicle distance between the oncoming vehicle (the vehicle traveling ahead of the following vehicle) and the following vehicle, steering of the following vehicle (for example, the steering amount and the steering speed), etc. when the following vehicle is traveling normally (namely, when an emergency maneuver such as sudden braking or sudden steering is not performed). The data related to steering may be data estimated based on the movement trajectory of the following vehicle, for example.

Also, the vehicle behavior data 27 includes a normal range set based on the statistical data related to each behavior of the following vehicle (for example, an upper limit value and a lower limit value taking into account a predetermined variation from a representative value such as an average value).

Further, the vehicle behavior data 27 includes statistical data related to the behavior of a certain vehicle positioned in an adjacent same-direction lane, which is an example of a predetermined lane (hereinafter, the certain vehicle in the adjacent same-direction lane will be referred to as a “parallel running vehicle”). The parallel running vehicle does not necessarily have to be a vehicle traveling side-by-side with the vehicle 1. The adjacent same-direction lane is a lane which is adjacent to the driving lane (the lane in which the vehicle 1 is traveling) and in which other vehicles travel in the same direction as the vehicle 1. The data related to the behavior of such a parallel running vehicle includes data related to braking of the parallel running vehicle (for example, the magnitude of deceleration), the inter-vehicle distance between the parallel running vehicle and its preceding vehicle, steering of the parallel running vehicle (for example, the steering amount and the steering speed), etc. when the parallel running vehicle is travelling normally.

Also, the vehicle behavior data 27 includes a normal range of the values of data related to each behavior of the parallel running vehicle similarly to the case of the following vehicle.

Note that the various data and programs used by the control device 20 may be stored not only in the storage device 19 but also in the external device 4. In other words, the external device 4 may function as a storage device of the vehicle 1.

The control device 20 is an electronic control unit (ECU) constituted of a computer configured to execute various processes. Note, however, that the control device 20 may include one or more other computers cooperating with the electronic control unit. The control device 20 includes a computational processing device (one or more processors such as a CPU, an MPU, and the like) and a memory (a ROM, a RAM, and the like). The computational processing device reads necessary software from the memory and/or the storage device 19, and executes predetermined computational processing according to the read software. The control device 20 may consist of a single piece of hardware or may be configured by multiple pieces of hardware. The control device 20 is connected to various components of the vehicle 1 via a communication network such as a controller area network (CAN) and controls the various components of the vehicle 1.

The control device 20 includes, as functional units thereof, an external environment recognizing unit 31, a travel control unit 32, a rush-out prediction unit 33 (an example of the prediction unit), a rush-out detection unit 34 (an example of the detection unit), a display control unit 35 (an example of the warning unit), a light emission control unit 36 (an example of the warning unit), a sound output control unit 37 (an example of the warning unit), and a communication control unit 38 (an example of the warning unit). At least some of the functional units of the control device 20 are implemented as a process executed by one or more processors according to a predetermined control program (an example of the control program for the moving body) as software. Also, at least some of the functional units of the control device 20 may be implemented as hardware such as an LSI, an ASIC, an FPGA, etc. or may be implemented as a combination of software and hardware.

The external environment recognizing unit 31 acquires data related to the detection result (hereinafter referred to as “external environment recognition data”) from the external environment sensor 14 and recognizes the state of the external environment of the vehicle 1 (an example of the surrounding situation) based on the external environment recognition data. For example, based on the external environment recognition data, the external environment recognizing unit 31 recognizes the target objects present around the vehicle 1 and recognizes the relative position of each target object with respect to the vehicle 1, the relative speed of each target object with respect to the vehicle 1, the distance from the vehicle 1 to each target object, etc. as the state of the external environment.

Also, the external environment recognizing unit 31 can acquire, as the state of the external environment, the type, position (absolute position), moving speed, past moving direction, and surrounding environment of each target object from the external environment recognition data according to a known method. Note that the external environment recognizing unit 31 may acquire these information based on not only the external environment recognition data but also the result of detection by the vehicle sensor 11 and/or the GNSS signal. The type of each target object may be another vehicle, a pedestrian, a bicycle, etc. The surrounding environment of each target object may include other pedestrians, other vehicles, traffic lights, roads (road shape and road width), etc. around the vehicle 1.

In a case where a target object is a pedestrian, the surrounding environment of the target object includes other pedestrians present on the opposite side of the road from the pedestrian regarded as the target object. In a case where a target object is an oncoming vehicle positioned (or traveling) in the oncoming lane, the surrounding environment of the target object includes still another vehicle present behind the oncoming vehicle (on the farther side from the own vehicle) (namely, the still another vehicle is a following vehicle which is traveling behind the oncoming vehicle) and the like. Also, in a case where a target object is a parallel running vehicle positioned (or traveling) in the adjacent same-direction lane, the surrounding environment of the target object includes still another vehicle present behind the parallel running vehicle (on the front side of the parallel running vehicle) (namely, the still another vehicle is a preceding vehicle traveling ahead of the parallel running vehicle) and the like.

The external environment recognizing unit 31 may estimate, as the state of the external environment, a future moving direction of each target object based on at least one of the type, position, moving speed, past moving direction, and surrounding environment of the target object. For example, based on the type, position, moving speed, past moving direction, and surrounding environment of the target object, the external environment recognizing unit 31 calculates a probability distribution (Gaussian distribution) with the direction with respect to the target object being a random variable. Moreover, the external environment recognizing unit 31 preferably estimates the direction with the highest probability density in the above probability distribution as a future moving direction of the target object.

The travel control unit 32 executes travel control (an example of movement control) of the vehicle 1 based on the state of the external environment of the vehicle 1 recognized by the external environment recognizing unit 31. For example, the travel control unit 32 executes acceleration and deceleration control and steering control of the vehicle 1 based on the relative position of each target object with respect to the vehicle 1 recognized by the external environment recognizing unit 31.

The travel control unit 32 executes preceding vehicle following control such as Adaptive Cruise Control (ACC) as the acceleration and deceleration control of the vehicle 1. In the preceding vehicle following control, the travel control unit 32 controls the driving device 6 and the brake device 7 to maintain the inter-vehicle distance between the vehicle 1 and its preceding vehicle within a predetermined range.

The acceleration and deceleration control that can be executed by the travel control unit 32 may include control executed when the rush-out prediction unit 33 determines that there is a possibility of rush-out of a moving obstacle to the driving lane (this control may be referred to as the “rush-out prediction control”). Also, the acceleration and deceleration control that can be executed by the travel control unit 32 may include control executed when the rush-out detection unit 34 detects rush-out of a moving obstacle to the driving lane (this control may be referred to as the “rush-out detection control”).

When the rush-out prediction unit 33 determines that there is a possibility that a moving obstacle may rush out to the driving lane (namely, to in front of the vehicle 1), the travel control unit 32 controls the driving device 6 and the brake device 7 in the rush-out prediction control to avoid collision with the moving obstacle. In this case, the control of the driving device 6 may include control to ease off the accelerator and to make the driving device 6 function as a regenerative brake. Similarly, when the rush-out detection unit 34 detects that the moving obstacle has rushed out to the driving lane (namely, to in front of the vehicle 1), the travel control unit 32 controls the driving device 6 and the brake device 7 in the rush-out detection control to avoid collision with the moving obstacle. Preferably, the deceleration (negative acceleration) of the vehicle 1 in the rush-out detection control is set greater than in the rush-out prediction control.

The travel control unit 32 executes lane keeping control such as lane keeping assist implemented by Lane Keeping Assist System (LKAS) as the steering control of the vehicle 1. In the lane keeping control, the travel control unit 32 controls the steering device 8 so that the vehicle 1 travels on a reference position within the lane partitioned by division lines (for example, near the widthwise center of the lane).

The steering control that can be executed by the travel control unit 32 can constitute at least part of the above-described rush-out prediction control and rush-out detection control. When the rush-out prediction unit 33 determines that there is a possibility that a moving obstacle may rush out to the driving lane, the travel control unit 32 executes, in the rush-out prediction control, emergency steering to avoid collision of the vehicle 1 with the moving obstacle in case the moving obstacle appears. More specifically, when it is determined that there is a possibility that a moving obstacle may rush out to the driving lane, the travel control unit 32 estimates a direction (area) in which the moving obstacle is not present (or moving) and automatically operates the steering device 8 in that direction to avoid collision with the moving obstacle. Similarly, when the rush-out detection unit 34 detects that the moving obstacle has rushed out to the driving lane (namely, to in front of the vehicle 1), the travel control unit 32 can execute emergency steering to avoid collision between the moving obstacle and the vehicle 1 in the rush-out detection control. Preferably, the steering speed of the steering wheel (namely, the steering speed of the wheels) in the rush-out detection control is set greater than in the rush-out prediction control.

The rush-out prediction unit 33 executes prediction regarding rush-out of a moving obstacle to the driving lane (hereinafter referred to as the rush-out prediction) based on the state of the external environment of the vehicle 1 recognized by the external environment recognizing unit 31.

For example, the external environment recognizing unit 31 can recognize, in an oncoming lane adjacent to the driving lane, a behavior of an oncoming vehicle group constituted of multiple other vehicles moving in the opposite direction to the vehicle 1 (an example of a group of opposite-direction moving bodies). Therefore, the rush-out prediction unit 33 can predict a possibility of rush-out of a moving obstacle from behind a certain oncoming vehicle in the oncoming vehicle group that is positioned in the forward direction (moving direction) of the vehicle 1 (namely, from a blind spot for the vehicle 1) based on the behavior of a following vehicle that is traveling behind the certain oncoming vehicle.

Here, in the case where a moving obstacle rushes out from behind the oncoming vehicle, the moving obstacle must rush out to in front of the following vehicle, and therefore, the following vehicle needs to take measures to avoid collision with the moving obstacle, such as sudden braking and sudden steering. At such an event, the behavior of the following vehicle becomes different from the normal one (from when there is no rush-out of a moving obstacle). Therefore, the rush-out prediction unit 33 can predict a possibility of rush-out of a moving obstacle based on the behavior of the following vehicle.

More specifically, the rush-out prediction unit 33 compares the data regarding the behavior of the following vehicle as the current state of the external environment with the corresponding vehicle behavior data 27, and when it is determined that the behavior of the following vehicle is different from the normal behavior (or out of the normal range), the rush-out prediction unit 33 determines that there is a possibility of rush-out of a moving obstacle.

For example, the oncoming vehicle may be another vehicle in the oncoming lane that is positioned closest to the vehicle 1 (or recognized by the external environment sensor 14 as the target object closest to the vehicle 1). The behavior of the following vehicle may include sudden braking of the following vehicle (for example, the magnitude of deceleration), the inter-vehicle distance between the oncoming vehicle and the following vehicle, and sudden steering of the following vehicle (for example, the steering amount and the steering speed). For example, sudden steering may be estimated based on the time series data of the position or the moving direction of the following vehicle for a fixed time period. Note that along with the movement (position change) of the vehicle 1, the oncoming vehicle and the following vehicle in the oncoming vehicle group that are related to the prediction of rush-out of a moving obstacle may be appropriately changed.

Also, for example, the external environment recognizing unit 31 can recognize, in an adjacent same-direction lane which is adjacent to the driving lane, a behavior of a parallel running vehicle group constituted of multiple other vehicles moving in the same direction as the vehicle 1 (an example of a group of same-direction moving bodies). Therefore, based on the behavior of a parallel running vehicle in the parallel running vehicle group that is positioned in the forward direction (moving direction) of the vehicle 1, the rush-out prediction unit 33 can predict a possibility of rush-out of a moving obstacle from behind the parallel running vehicle (namely, from a blind spot for the vehicle 1, the blind spot being in front of the parallel running vehicle in this case).

Here, in the case where a moving obstacle rushes out from behind the parallel running vehicle, the moving obstacle must rush out to in front of the parallel running vehicle, and therefore, the parallel running vehicle needs to take measures to avoid collision with the moving obstacle, such as sudden braking and sudden steering. At such an event, the behavior of the parallel running vehicle becomes different from the normal one. Therefore, the rush-out prediction unit 33 can predict a possibility of rush-out of a moving obstacle based on the behavior of the parallel running vehicle.

More specifically, the rush-out prediction unit 33 compares the data regarding the behavior of the parallel running vehicle as the current state of the external environment with the corresponding vehicle behavior data 27, and when it is determined that the behavior of the parallel running vehicle is different from the normal behavior (or out of the normal range), the rush-out prediction unit 33 determines that there is a possibility of rush-out of a moving obstacle.

For example, the parallel running vehicle may be another vehicle in the adjacent same-direction lane that is positioned closest to the vehicle 1 (or recognized by the external environment sensor 14 as the target object closest to the vehicle 1). The behavior of the parallel running vehicle may include sudden braking of the parallel running vehicle (for example, the magnitude of deceleration), the inter-vehicle distance between the parallel running vehicle and the preceding vehicle which is moving ahead of the parallel running vehicle, and sudden steering of the parallel running vehicle (for example, the steering amount and the steering speed). Note that along with the movement (position change) of the vehicle 1, the parallel running vehicle and the preceding vehicle in the parallel running vehicle group that are related to the prediction of rush-out of a moving obstacle may be appropriately changed.

The rush-out detection unit 34 detects rush-out of a moving obstacle to the driving lane based on the state of the external environment of the vehicle 1 recognized by the external environment recognizing unit 31.

For example, the external environment recognizing unit 31 can recognize a behavior of a moving obstacle rushing out to the driving lane from the oncoming lane adjacent to the driving lane. Such recognition of a behavior of a moving obstacle can be achieved, for example, by executing an image recognition process by the external environment recognizing unit 31 on the images captured by the external environment cameras 21. The detection of rush-out of a moving obstacle by the rush-out detection unit 34 is possible, for example, when at least a part of the moving obstacle can be directly recognized by the external environment recognizing unit 31 (for example, when a moving obstacle positioned behind the oncoming vehicle moves to a position that can be recognized from the vehicle 1).

Also, for example, the external environment recognizing unit 31 can recognize a behavior of a moving obstacle rushing out to the driving lane from the adjacent same-direction lane which is adjacent to the driving lane. The detection of rush-out of a moving obstacle by the rush-out detection unit 34 is possible, for example, when at least a part of the moving obstacle can be directly recognized by the external environment recognizing unit 31 (for example, when a moving obstacle positioned behind the parallel running vehicle moves to a position that can be recognized from the vehicle 1).

The display control unit 35 controls display of the HUD 15. More specifically, the display control unit 35 switches the image displayed by the HUD 15 based on the recognition result by the external environment recognizing unit 31, the execution state of travel control by the travel control unit 32, and the like.

The display control of the HUD 15 by the display control unit 35 can constitute at least part of the above-described rush-out prediction control and rush-out detection control. In the rush-out prediction control, the display control unit 35 can warn the user of the vehicle 1 that there is a possibility that a moving obstacle may rush out to the lane in which the vehicle 1 is positioned by making the HUD 15 display texts, figures, etc. Similarly, in the rush-out detection control, the travel control unit 32 can warn the user of the vehicle 1 that a moving obstacle has rushed out to the lane in which the vehicle 1 is positioned.

The light emission control unit 36 can control the light emission (on/off, an amount of light, etc.) of the light emitting device 16.

The light emission control of the light emitting device 16 by the light emission control unit 36 can constitute at least part of the above-described rush-out prediction control and rush-out detection control. In the rush-out prediction control, the light emission control unit 36 can provide a warning (for example, can notify that there is a possibility of sudden braking of the vehicle 1) to the surroundings of the vehicle 1 (for example, pedestrians and other vehicles around the vehicle 1) by making the light emitting device 16 emit light in an unusual way. The unusual light emission may include flashing of the light emitting device 16. Similarly, in the rush-out detection control, the light emission control unit 36 can provide a warning to the surroundings of the vehicle 1 by making the light emitting device 16 emit light in an unusual way.

The sound output control unit 37 can control sound output from the sound output device 17.

The control of sound output from the sound output device 17 by the sound output control unit 37 can constitute at least part of the above-described rush-out prediction control and rush-out detection control. In the rush-out prediction control, the sound output control unit 37 can make the sound output device 17 (namely, at least one of the interior speaker and the exterior speaker) output a sound prepared in advance (for example, a voice message that there is a possibility of sudden braking of the vehicle 1) to warn to at least one of the user of the vehicle 1 and the surroundings of the vehicle 1. Similarly, in the rush-out detection control, the sound output control unit 37 can make the sound output device 17 output a sound prepared in advance (for example, a voice message that the vehicle 1 will perform sudden braking).

The communication control unit 38 can control communication of the communication device 18 with the external device 4, the user terminal 5, etc.

The communication control of the communication device 18 by the communication control unit 38 can constitute at least part of the above-described rush-out prediction control and rush-out detection control. In the rush-out prediction control, the communication control unit 38 can transmit a warning using a known communication tool (for example, a text or voice message that there is a possibility of sudden braking of the vehicle 1) to the user terminal 5. Similarly, in the rush-out detection control, the communication control unit 38 can transmit a warning message using a known communication tool (for example, a text or voice message that the vehicle 1 will perform sudden braking) to the user terminal 5.

In the following, for convenience of explanation, the functional units of the control device 20 are not distinguished from one another and are simply referred to as “the control device 20.”

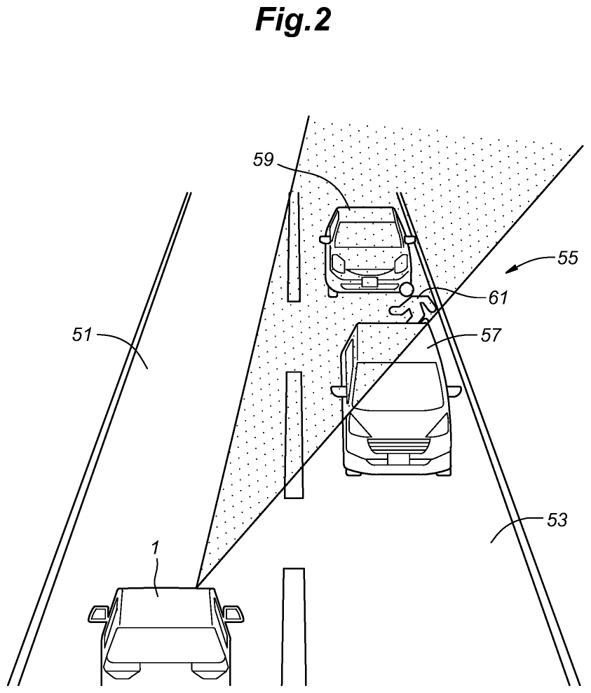

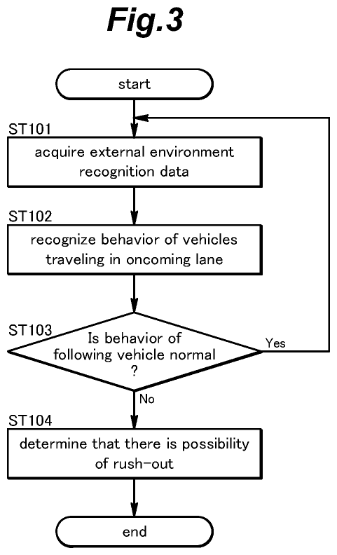

Next, with reference to FIGS. 2 and 3, description will be made of a process for prediction of rush-out of a moving obstacle from the oncoming lane to the driving lane by the control device 20.

Here, as illustrated in FIG. 2, a case where there is an oncoming vehicle group 55 (an example of the group of opposite-direction moving bodies) in an oncoming lane 53 (an example of the second lane) adjacent to a driving lane 51 (an example of the first lane) of the vehicle 1 (own vehicle) is shown as an example. The oncoming vehicle group 55 includes an oncoming vehicle 57 (an example of the first another moving body) which is positioned closest to the vehicle 1 in the moving direction of the vehicle 1 (here, a right forward direction) and a following vehicle 59 (an example of the second another moving body) which is moving behind the oncoming vehicle 57.

Also, behind the oncoming vehicle 57 (between the oncoming vehicle 57 and its following vehicle 59), there is a pedestrian 61 (an example of the moving obstacle) who is moving from the oncoming lane 53 toward the driving lane 51 (namely, there is a possibility of rush-out to the driving lane 51). For example, the oncoming vehicle 57 is temporarily stopped or is traveling at a low speed. Note that other vehicles may be additionally present in front of the oncoming vehicle 57 and/or behind the following vehicle 59 and constitute the oncoming vehicle group 55.

As shown in FIG. 3, in the process of rush-out prediction, the control device 20 first acquires external environment recognition data from the external environment sensor 14 (ST101), and based on the external environment recognition data, the control device 20 recognizes the behavior of the pedestrian 61 present in the surroundings of the vehicle 1 (particularly, present in the moving direction of the vehicle 1) and the behavior of the oncoming vehicle group 55 traveling in the oncoming lane 53 (ST102). The behavior of the oncoming vehicle group 55 includes at least one of braking of the following vehicle 59 (for example, the magnitude of deceleration), the inter-vehicle distance between the oncoming vehicle 57 and the following vehicle 59, and steering of the following vehicle 59 (for example, the steering amount and the steering speed).

Next, the control device 20 refers to the vehicle behavior data 27 corresponding to the behavior of the following vehicle 59 in the oncoming vehicle group 55, and determines whether a data value related to the behavior of the current following vehicle 59 is within the normal range (whether the behavior is a normal behavior) (ST103). For example, in step ST103, the control device 20 determines whether the deceleration of the following vehicle 59 in a predetermined time is within the normal range (whether the deceleration is a normal deceleration).

When the behavior of the current following vehicle 59 is a normal behavior (Yes in ST103), the control device 20 returns to the step ST101 and executes the same process described above. On the other hand, when the behavior of the current following vehicle 59 is different from a normal behavior (namely, the data value related to the behavior of the following vehicle 59 is not within the normal range) (No in ST103), the control device 20 determines that there is a possibility of rush-out of a moving obstacle (the pedestrian 61 or the like) (ST104).

In this way, the control device 20 can predict rush-out of a moving obstacle from behind the oncoming vehicle 57 which is present around the vehicle 1 (here, in the oncoming lane 53 adjacent to the driving lane 51 (the lane in which the vehicle 1 is positioned)) based on the behavior of the following vehicle 59 which is positioned in the oncoming lane 53 and is traveling behind the oncoming vehicle 57.

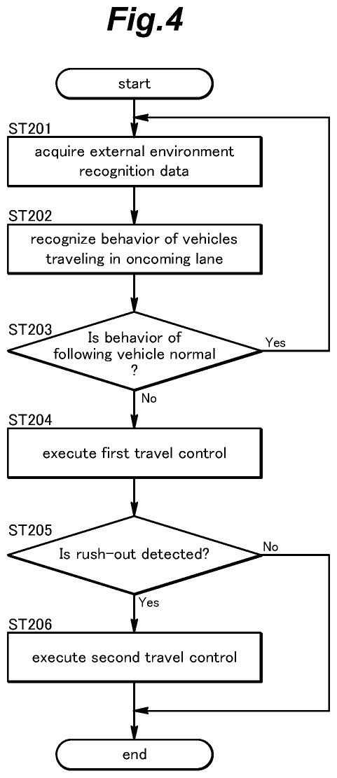

Next, with reference to FIGS. 2 and 4, description will be made of a process for the rush-out prediction control and rush-out detection control executed by the control device 20.

As shown in FIG. 4, the control device 20 first executes steps ST201 to ST203 which are the same as steps ST101 to ST103 in FIG. 3, respectively.

When the behavior of the current following vehicle 59 is a normal behavior (Yes in ST203), the control device 20 returns to the step ST201 and executes the same process described above. On the other hand, when the behavior of the current following vehicle 59 is different from a normal behavior (No in ST203), the control device 20 determines that there is a possibility of rush-out of a moving obstacle (the pedestrian 61 or the like) and executes first travel control (ST204). For example, as the first travel control in step ST204, the control device 20 may make the driving device 6 function as a regenerative brake to decelerate the vehicle 1.

Next, based on the behavior of the moving obstacle (the pedestrian 61 or the like), the control device 20 determines whether rush-out of a moving obstacle to the driving lane 51 is detected (ST205). For example, in step ST205, the control device 20 determines that rush-out is detected (there is rush-out) when the pedestrian 61 (at least a part of the image region of the pedestrian 61) is positioned in the driving lane 51 in the image captured by the external environment cameras 21.

When it is determined that there is no rush-out of a moving obstacle (No in ST205), the control device 20 ends the series of processing. On the other hand, when it is determined that there is rush-out (Yes in ST205), the control device 20 executes second travel control (ST206). For example, as the second travel control in step ST206, the control device 20 may control the brake device 7 to quickly brake the vehicle 1. The deceleration of the vehicle 1 by the second travel control is set greater than the deceleration the vehicle 1 by the first travel control.

In this way, the control device 20 executes different travel controls in stages (the first and second movement controls) when it is determined that there is a possibility of rush-out of a moving obstacle based on the behavior of the following vehicle 59 and when it is determined that the rush-out is detected based on the behavior of the moving obstacle, and therefore, appropriate control can be executed in relation to rush-out of the moving obstacle.

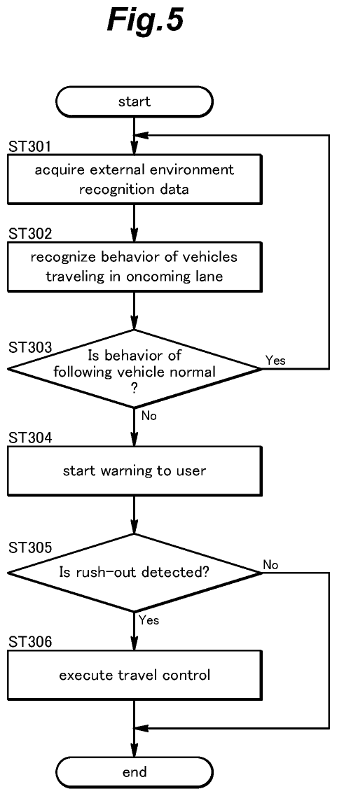

Next, with reference to FIGS. 2 and 5, a first modification of the process of rush-out prediction control and rush-out detection control shown in FIG. 4 will be described.

As shown in FIG. 5, the control device 20 first executes steps ST301 to ST303 which are the same as steps ST201 to ST203 in FIG. 4, respectively.

When the behavior of the current following vehicle 59 is a normal behavior (Yes in ST303), the control device 20 returns to step ST301 and executes the same process described above. On the other hand, when the behavior of the current following vehicle 59 is different from a normal behavior (No in ST303), the control device 20 determines that there is a possibility of rush-out of a moving obstacle (the pedestrian 61 or the like) and executes (starts) warning to the user of the vehicle 1 (ST304). The warning to the user in step ST304 includes at least one of display of warning information on the HUD 15, warning by sound output from the sound output device 17 (interior speaker), and transmission of a warning message to the user terminal 5.

Next, as in step ST205 of FIG. 4, the control device 20 determines whether rush-out of a moving obstacle to the driving lane 51 is detected based on the behavior of the moving obstacle (the pedestrian 61 or the like) (ST305).

When it is determined that there is no rush-out of a moving obstacle (No in ST305), the control device 20 ends the series of processing. On the other hand, when it is determined that there is rush-out (Yes in ST305), the control device 20 executes travel control corresponding to rush-out of a moving obstacle (ST306). For example, as the travel control in step ST306, the control device 20 may control the brake device 7 to quickly brake the vehicle 1.

In this way, when it is determined that there is a possibility of rush-out of a moving obstacle based on the behavior of the following vehicle 59, the control device 20 executes (starts) warning to the user, and when the rush-out is detected based on the behavior of the moving obstacle, the control device 20 executes travel control. Therefore, it is possible to execute control related to rush-out of a moving obstacle without discomfort to the user.

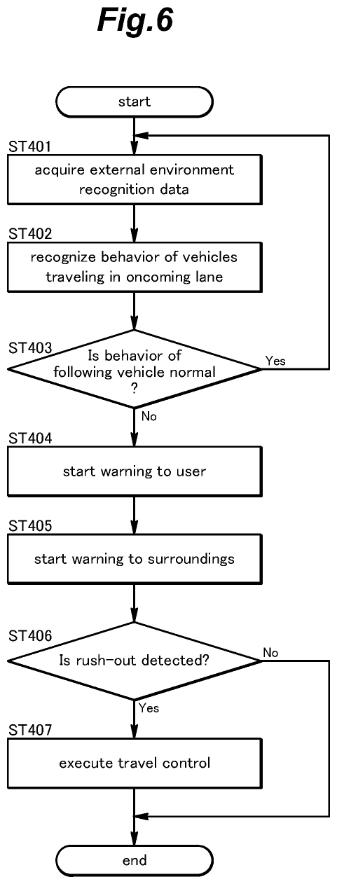

Next, with reference to FIGS. 2 and 6, a second modification of the process of rush-out prediction control and rush-out detection control shown in FIG. 4 will be described.

As shown in FIG. 6, the control device 20 first executes steps ST401 to ST404, ST406, and ST407 which are the same as steps ST301 to ST306 in FIG. 5, respectively.

On the other hand, in the second modification, when the behavior of the current following vehicle 59 is different from a normal behavior (No in ST403), the control device 20 executes (starts) warning to the user of the vehicle 1 (ST404) and in addition executes (starts) warning to the surroundings of the vehicle 1 (ST405). The warning to the surroundings in step ST505 includes at least one of warning by light emission from the light emitting device 16 and warning by sound output from the sound output device 17 (exterior speaker).

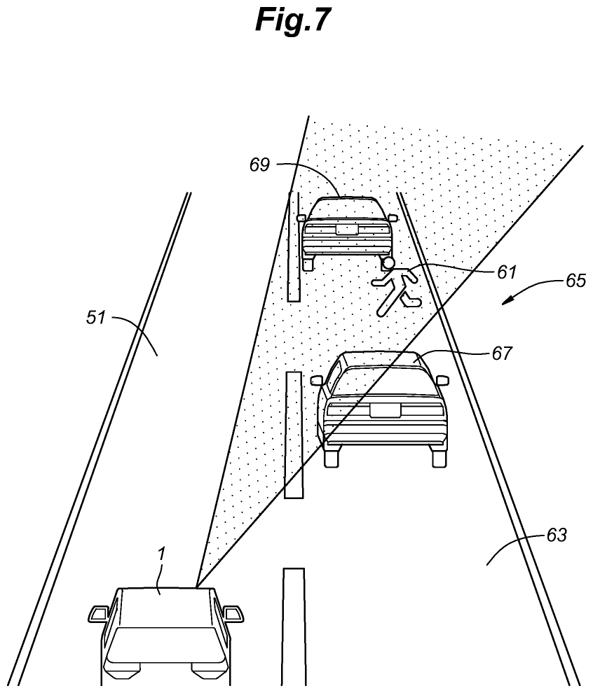

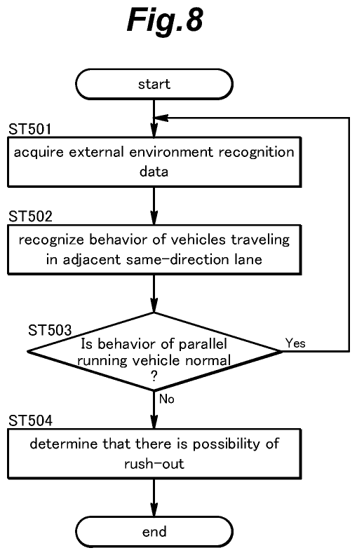

Next, with reference to FIGS. 7 and 8, description will be made of a process for prediction of rush-out of a moving obstacle from the adjacent same-direction lane to the driving lane by the control device 20.

Here, as illustrated in FIG. 7, a case where there is a parallel running vehicle group 65 (an example of a group of same-direction moving bodies) in an adjacent same-direction lane 63 (an example of the third lane) which is adjacent to the driving lane 51 of the vehicle 1 (an example of the first lane) is shown as an example. The parallel running vehicle group 65 includes a parallel running vehicle 67 (an example of the third another moving body) which is closest to the vehicle 1 in the moving direction (here, in the right forward direction) of the vehicle 1 and is moving in the same direction as the vehicle 1 and a preceding vehicle 69 traveling ahead of the parallel running vehicle 67.

Also, behind the parallel running vehicle 67 (between the parallel running vehicle 67 and its preceding vehicle 69), there is a pedestrian 61 who is moving from the adjacent same-direction lane 63 toward the driving lane 51 (namely, there is a possibility of rush-out to the driving lane 51). Note that other vehicles may be additionally present behind the parallel running vehicle 67 and/or in front of the preceding vehicle 69 and constitute the parallel running vehicle group 65.

As shown in FIG. 8, in the process of rush-out prediction, the control device 20 first acquires external environment recognition data from the external environment sensor 14 (ST501), and based on the external environment recognition data, the control device 20 recognizes the behavior of the pedestrian 61 present in the surroundings of the vehicle 1 (particularly, present in the forward direction) and the behavior of the parallel running vehicle group 65 traveling in the adjacent same-direction lane 63, etc. (ST502). The behavior of the parallel running vehicle group 65 includes at least one of braking of the parallel running vehicle 67 (for example, the magnitude of deceleration), the inter-vehicle distance between the parallel running vehicle 67 and the preceding vehicle 69, and steering of the parallel running vehicle 67 (for example, the steering amount and the steering speed).

Next, the control device 20 refers to the vehicle behavior data 27 corresponding to the behavior of the parallel running vehicle 67 in the parallel running vehicle group 65 and determines whether a data value related to the behavior of the current parallel running vehicle 67 is within the normal range (whether the behavior is a normal behavior) (ST503). For example, in step ST503, the control device 20 determines whether the deceleration of the parallel running vehicle 67 is within the normal range (whether the deceleration is a normal deceleration).

When the behavior of the current parallel running vehicle 67 is a normal behavior (Yes in ST503), the control device 20 returns to step ST501 and executes the same process described above. On the other hand, when the behavior of the current parallel running vehicle 67 is different from a normal behavior (No in ST503), the control device 20 determines that there is a possibility of rush-out of a moving obstacle (the pedestrian 61 or the like) (ST504).

In this way, based on the behavior of the parallel running vehicle 67 moving in the adjacent same-direction lane 63 which is adjacent to the driving lane 51 in which the vehicle 1 is positioned, the control device 20 can predict rush-out of a moving obstacle from behind the parallel running vehicle 67 which is present around the vehicle 1 (or rush-out of a moving obstacle positioned in front of the parallel running vehicle 67).

Note that FIG. 8 corresponds to the process in which the target whose behavior is to be recognized to predict a possibility of rush-out of the moving obstacle is changed from the following vehicle 59 shown in FIG. 3 to the parallel running vehicle 67. As in the case of FIG. 8, each process shown in FIGS. 4 to 6 also can be executed with the following vehicle 59 being changed to the parallel running vehicle 67.

### Second Embodiment

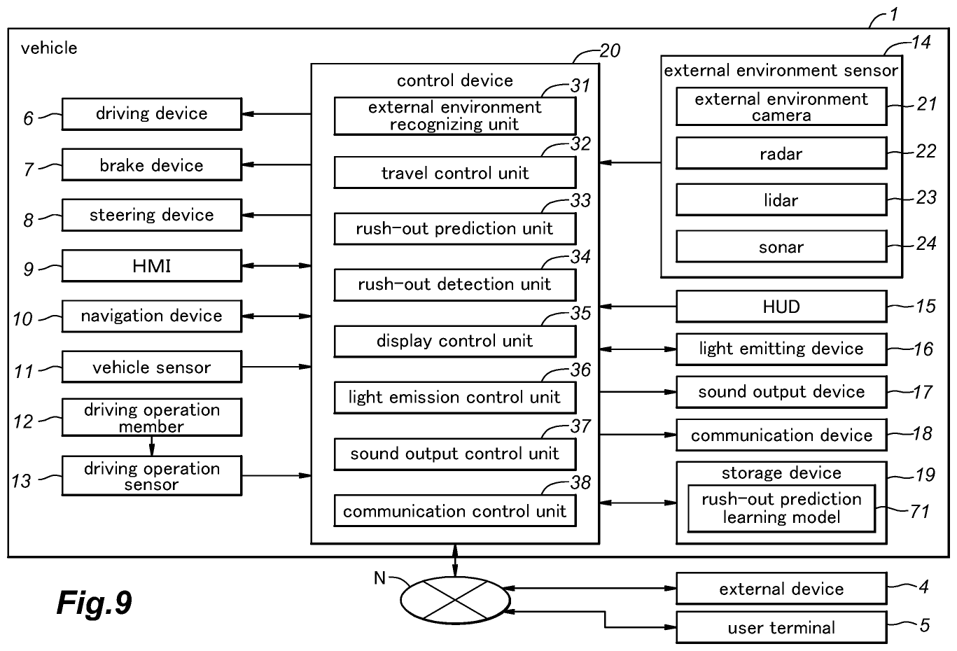

Next, with reference to FIG. 9, a vehicle 1 according to the second embodiment will be described. In FIG. 9, components similar to those of the vehicle 1 according to the first embodiment are denoted by same reference signs and the detailed description thereof will be omitted. Also, features of the vehicle 1 according to the second embodiment not particularly mentioned in the following are the same as in the first embodiment.

In the second embodiment, the storage device 19 stores, instead of the vehicle behavior data 27, a rush-out prediction learning model 71 generated by machine learning. In the machine learning, a known algorithm such as linear regression, logistic regression, neural network, and k-nearest neighbors algorithm may be used. In the machine learning, an oncoming vehicle, a parallel running vehicle or the like is assumed as a target vehicle (a target whose behavior is to be recognized), and the data related to braking of the target vehicle (for example, the magnitude of deceleration), the inter-vehicle distance between the target vehicle and its preceding vehicle, steering of the target vehicle (for example, the steering amount and the steering speed) or the like when the target vehicle is traveling normally is used as the training data.

By using the state of the external environment of the vehicle 1 recognized by the external environment recognizing unit 31, the rush-out prediction unit 33 predicts a possibility of rush-out of a moving obstacle based on the rush-out prediction learning model 71.

Note that as the rush-out prediction learning model 71, different models may be used in the case where the target vehicle is an oncoming vehicle and in the case where the target vehicle is a parallel running vehicle (namely, multiple learning models may be used).

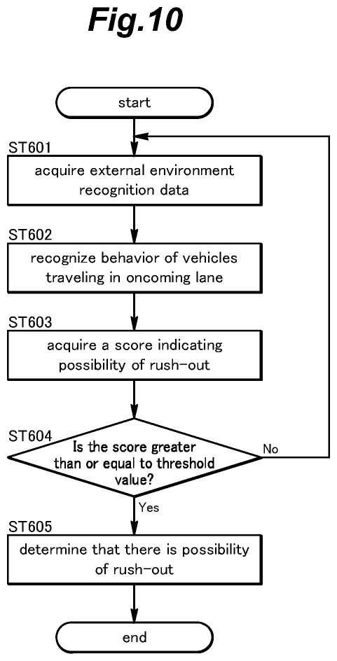

Next, with reference to FIGS. 2 and 10, description will be made of a process for prediction of rush-out of a moving obstacle from the oncoming lane to the driving lane by the control device 20 according to the second embodiment.

As shown in FIG. 10, in the process of rush-out prediction, the control device 20 first executes steps ST601 to ST602 which are the same as steps ST101 to ST102 in FIG. 3, respectively.

Next, the control device 20 acquires a score indicating a possibility of rush-out of a moving obstacle (namely, the reliability of prediction) based on the rush-out prediction learning model 71 (ST603). Then, when the value of the score is less than a preset threshold value (No in ST604), the control device 20 returns to step ST601 and executes the same process described above. On the other hand, when the value of the score is greater than or equal to the preset threshold value (Yes in ST604), the control device 20 determines that there is a possibility of rush-out of a moving obstacle (ST605).

Note that FIG. 10 shows the case where the process of rush-out prediction using the vehicle behavior data 27 shown in FIG. 3 is changed to the process of rush-out prediction using a learning model. As in the case of FIG. 10, each process shown in FIGS. 4 to 6 also can be executed with the process using the vehicle behavior data 27 with the process using a learning model.

Concrete embodiments of the present invention have been described in the foregoing, but the present invention is not limited to the above embodiments and may be modified or altered in various ways.

For example, the control device, control method, and control program for a moving body according to the present invention can be applied not only to control of a four-wheeled automobile but also to control of other moving bodies such as a motorcycle, a watercraft, and an aircraft moving in a predetermined lane. Also, the control device, control method, and control program for a moving body according to the present invention can be applied to an automatic driving vehicle that does not require a driver.

1. A control device for a moving body, comprising:
an external environment recognizing unit that acquires external environment recognition data around the moving body from an external environment sensor and recognizes a surrounding situation of the moving body based on the external environment recognition data; and
a prediction unit that, based on the surrounding situation, performs prediction regarding rush-out of a moving obstacle to a first lane in which the moving body is positioned,
wherein the external environment recognizing unit recognizes, as the surrounding situation, a behavior of a group of opposite-direction moving bodies constituted of multiple other moving bodies moving in a second lane adjacent to the first lane in a direction opposite to a moving direction of the moving body, the group of opposite-direction moving bodies including a first another moving body which is positioned in the moving direction of the moving body and a second another moving body which is moving behind the first another moving body, and
the prediction unit predicts a possibility of rush-out of the moving obstacle based on a behavior of the second another moving body.

2. The control device according to claim 1, further comprising a storage unit that stores statistical data related to a normal behavior of the second another moving body,
wherein the prediction unit determines that there is a possibility of rush-out of the moving obstacle when the behavior of the second another moving body recognized by the external environment recognizing unit is determined to be different from the normal behavior based on the statistical data.

3. The control device according to claim 2, wherein the prediction unit determines that there is a possibility of rush-out of the moving obstacle when the behavior of the second another moving body includes a deceleration of the second another moving body greater than a deceleration of the first another moving body.

4. The control device according to claim 1, wherein the external environment recognizing unit recognizes, as the surrounding situation, a behavior of the moving obstacle,
the control device further comprises:
a detection unit that detects rush-out of the moving obstacle from the second lane to the first lane based on the behavior of the moving obstacle; and
a control unit that performs movement control of the moving body according to rush-out of the moving obstacle, and
the control unit executes first movement control when it is determined by the prediction unit that there is a possibility of rush-out of the moving obstacle and executes second movement control when, after execution of the first movement control, rush-out of the moving obstacle is detected by the detection unit.

5. The control device according to claim 1, wherein the external environment recognizing unit recognizes, as the surrounding situation, a behavior of the moving obstacle,
the control device further comprises:
a detection unit that detects rush-out of the moving obstacle from the second lane to the first lane based on the behavior of the moving obstacle;
a control unit that performs movement control of the moving body according to rush-out of the moving obstacle; and
a warning unit that provides a warning according to rush-out of the moving obstacle,
the warning unit provides a warning to a user of the moving body when it is determined by the prediction unit that there is a possibility of rush-out of the moving obstacle, and
the control unit executes the movement control when, after the warning, rush-out of the moving obstacle is detected by the detection unit.

6. The control device according to claim 5, wherein the warning unit provides a further warning to surroundings of the moving body when it is determined by the prediction unit that there is a possibility of rush-out of the moving obstacle.

7. The control device according to claim 1, wherein the moving body is a vehicle traveling in a certain lane as the first lane, and
the group of opposite-direction moving bodies includes multiple other vehicles traveling in, as the second lane, an oncoming lane adjacent to the certain lane.

8. The control device according to claim 1, wherein the external environment recognizing unit recognizes, based on the external environment recognition data, a behavior of a group of same-direction moving bodies constituted of multiple other moving bodies moving in a third lane adjacent to the first lane in a same direction as the moving body, and
the prediction unit predicts a possibility of rush-out of the moving obstacle from the third lane to the first lane based on a behavior of a third another moving body, which is a moving body in the group of same-direction moving bodies that is positioned in the moving direction of the moving body.

9. The control device according to claim 1, wherein the prediction unit acquires, as the prediction regarding rush-out of the moving obstacle, a score indicating the possibility of rush-out of the moving obstacle based on a learned learning model which is obtained by carrying out machine learning for estimating the possibility of rush-out of the moving obstacle.

10. A control method for a moving body, in which one or more processors execute:
acquiring external environment recognition data around the moving body from an external environment sensor;
recognizing, based on the external environment recognition data, a behavior of a group of opposite-direction moving bodies constituted of multiple other moving bodies moving in a second lane adjacent to a first lane, in which the moving body is positioned, in a direction opposite to a moving direction of the moving body, the group of opposite-direction moving bodies including a first another moving body which is positioned in the moving direction of the moving body and a second another moving body which is moving behind the first another moving body; and
predicting a possibility of rush-out of a moving obstacle from the second lane to the first lane based on a behavior of the second another moving body.

11. A non-transitory computer-readable storage medium, comprising a stored program, wherein the program, when executed by a processor, executes the method of claim 10.
